(19) United States
(12) Patent Application Publication
(10) Pub. No.: US 2014/0089841 A1
(43) Pub. Date: Mar. 27, 2014

(54) DEVICE AND METHOD FOR PROVIDING APPLICATION INTERFACE BASED ON WRITING INPUT

(71) Applicant: Pantech Co., Ltd., Seoul (KR)

(72) Inventors: Jong Gon KIM, Seoul (KR); Jin Young ROH, Seoul (KR); Mi Sun HWANG, Seoul (KR)

(73) Assignee: Pantech Co., Ltd., Seoul (KR)

(21) Appl. No.: 14/035,162

(22) Filed: Sep. 24, 2013

(30) Foreign Application Priority Data
Sep. 24, 2012 (KR) 10-2012-0105731

(51) Int. Cl. G06F 3/0488

(52) U.S. Cl. CPC G06F 3/04883
USPC 715/780

(57) ABSTRACT

Disclosed is a device and method for providing an application interface based on a writing input. The method for providing an application interface based on a writing input includes providing a writing interface including a writing input interface in a first area of the writing interface and a function input interface in a second area of the writing interface, the writing input interface being configured to receive and display a first writing input, and the function input interface being configured to receive a second writing input; based on the first writing input and/or the second writing input, determining a function of an application; and executing the determined function of the application in association with the first writing input.

### CROSS-REFERENCE TO RELATED APPLICATION

This application claims priority from and the benefit under 35 U.S.C. §119(a) of Korean Patent Application No. 10-2012-0105731, filed on Sep. 24, 2012, which is hereby incorporated by reference for all purposes as if fully set forth herein.

### BACKGROUND

1. Field

The present disclosure relates to a device and method for implementing a particular function based on a handwriting input, and more particularly, to a device and method for implementing a particular function associated with the recognized input based on a handwriting input by a user.

2. Discussion of the Background

Along with the development of information communication technologies and the widespread use of smart phones, the kinds of available applications for smartphones rapidly increased. Numerous kinds of applications have been developed for the same purpose. Therefore, in order to determine an application, a task, or a work to be performed, a user should search for, select, and execute a suitable application among numerous applications and select a required function. According to conventional schemes, a user may access a desired application by using an icon or folder in the background screen of a smart phone.

However, in a general application executing procedure, in order to execute an application required for performing the application, task, or work, a user should search for and select the application at least once (for example, selection of an icon). In addition, after the application is executed, the user should select a function subsequently (for example, input of a phone number to make a call, selection of a date for scheduling, or the like). Therefore, the user should input gestures, touch inputs, or key inputs many times, which results in inconvenience for the user.

### SUMMARY

The present disclosure relates to a device and method for selecting and executing an application based on a handwriting input and applying associated content on a single display screen, which gives convenience to the user by reducing multiple steps for using the application.

According to an aspect of the present disclosure, it is possible to select and execute an application and apply associated content, in a single display screen based on a recognized text. Accordingly, execution steps or processes are reduced, which provides a faster and more convenient interface to a user.

Additional features of the invention will be set forth in the description which follows, and in part will be apparent from the description, or may be learned by practice of the invention.

Exemplary embodiments of the present invention provide a method for providing an application interface based on a writing input, the method including: providing a writing interface including a writing input interface in a first area of the writing interface and a function input interface in a second area of the writing interface, the writing input interface being configured to receive and display a first writing input, and the function input interface being configured to receive a second writing input; based on the first writing input and/or the second writing input, determining a function of an application; and executing the function of the application in association with the first writing input.

Exemplary embodiments of the present invention provide a method for providing an application interface based on a writing input, the method including: providing a writing interface configured to receive a first writing input and a second writing input; recognizing a data entry from the first writing input, the data entry being utilized by a function of one or more applications; determining a function of a first application corresponding to the second writing input; and executing the determined function of the first application by utilizing the data entry.

Exemplary embodiments of the present invention provide a method for providing an application interface based on a writing input, the method including: providing a writing interface including a writing input interface in a first area of the writing interface and a function input interface in a second area of the writing interface, the writing input interface being configured to receive a first writing input, and the function input interface being configured to display, in response to the first writing input, one or more retrieved applications associated with the first writing input; and displaying the one or more retrieved applications associated with the first writing input; and in response to a selection of an application from among the one or more retrieved applications, executing a function of the selected application in association with the first writing input.

Exemplary embodiments of the present invention provide a non-transitory computer-readable medium including an executable program for instructing a computer, when executed by the computer, to perform: providing a writing interface including a writing input interface in a first area of the writing interface and a function input interface in a second area of the writing interface, the writing input interface being configured to receive and display a first writing input, and the function input interface being configured to receive a second writing input; based on the first writing input and/or the second writing input, determining a function of an application; and executing the determined function of the application in association with the first writing input.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a device to provide an application control based on a recognized handwriting input according to an exemplary embodiment of the present invention.

FIG. 2 is a diagram showing a writing interface unit according to an exemplary embodiment of the present invention.

FIG. 3 is a diagram showing a handwriting user interface for controlling applications according to an exemplary embodiment of the present invention.

FIG. 4 is a diagram showing an application control function executed based on handwriting data and function information according to an exemplary embodiment of the present invention.

FIG. 5 is a table showing function information according to an exemplary embodiment of the present invention.

FIG. 6 is a diagram showing a control unit according to an exemplary embodiment of the present invention.

FIG. 7A and FIG. 7B are diagrams showing that a text input to a writing input unit is corrected according to an exemplary embodiment of the present invention.

FIG. 8 is a diagram showing an application for performing a searching function recommended based on a text input to the writing input unit is executed according to an exemplary embodiment of the present invention.

FIG. 9 is a diagram showing an operation of executing an application for performing a call generating function recommended based on a text input to the writing input unit according to an exemplary embodiment of the present invention.

FIG. 10 is a diagram showing an operation of executing an application for performing a scheduling function recommended based on a text input to the writing input unit according to an exemplary embodiment of the present invention.

FIG. 11 is diagram showing an operation of executing an application for performing a calculating function recommended based on a text input to the writing input unit according to an exemplary embodiment of the present invention.

FIG. 12 is a flowchart illustrating a method for implementing a function based on a handwriting input according to an exemplary embodiment of the present invention.

FIG. 13 is a flowchart illustrating an operation of receiving information according to an exemplary embodiment of the present invention.

FIG. 14 is a flowchart illustrating an operation of searching for a specific application according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

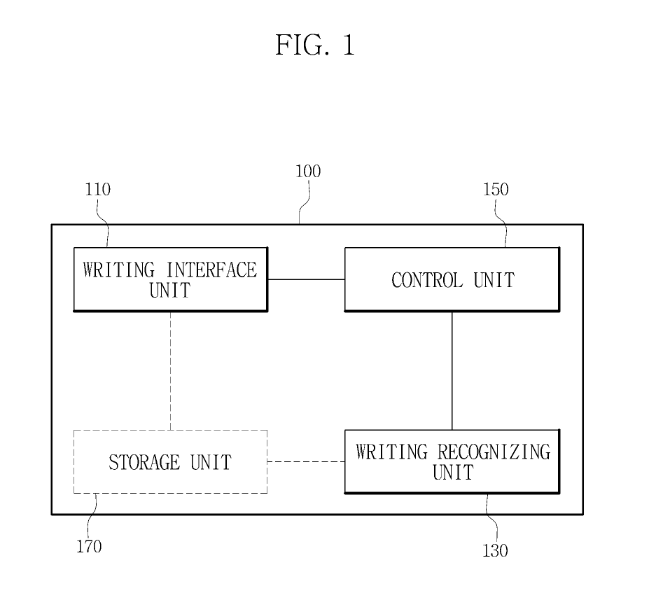

Various aspects of the device will be described with reference to FIG. 1 to FIG. 6, but aspects are not limited thereto.

FIG. 1 is a diagram showing a device to provide an application control based on a recognized handwriting input according to an exemplary embodiment of the present invention. As shown in FIG. 1, the device 100 may include a writing interface unit 110, a writing recognizing unit 130, and a control unit 150. Further, the device 100 may include a storage unit 170 internally or externally, for example, the storage unit 170 may be a cloud storage unit. The device 100 includes a touch screen or a touch panel in order to receive a handwriting touch input by a user and the writing interface unit 110 may be implemented on or may be operated in association with a touch screen or a touch panel. The handwriting touch input may include a touch of a user's hand, a touch of a touch pen or stylus pen, and the like.

Since the writing interface unit 110 is implemented on a touch screen or a touch panel, the writing interface unit 110 may receive a touch or writing input by the user (an input generated by a finger of a user or an electronic pen) and display the written content.

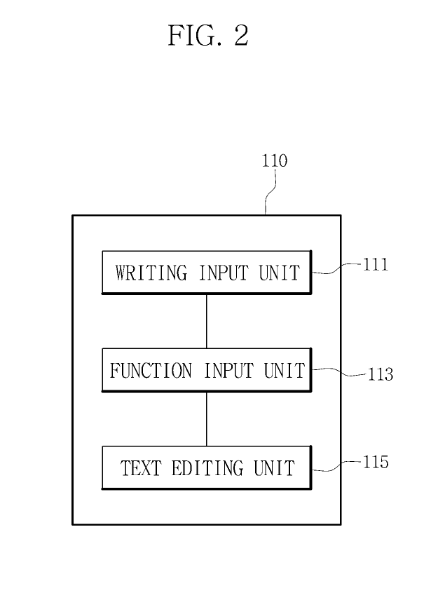

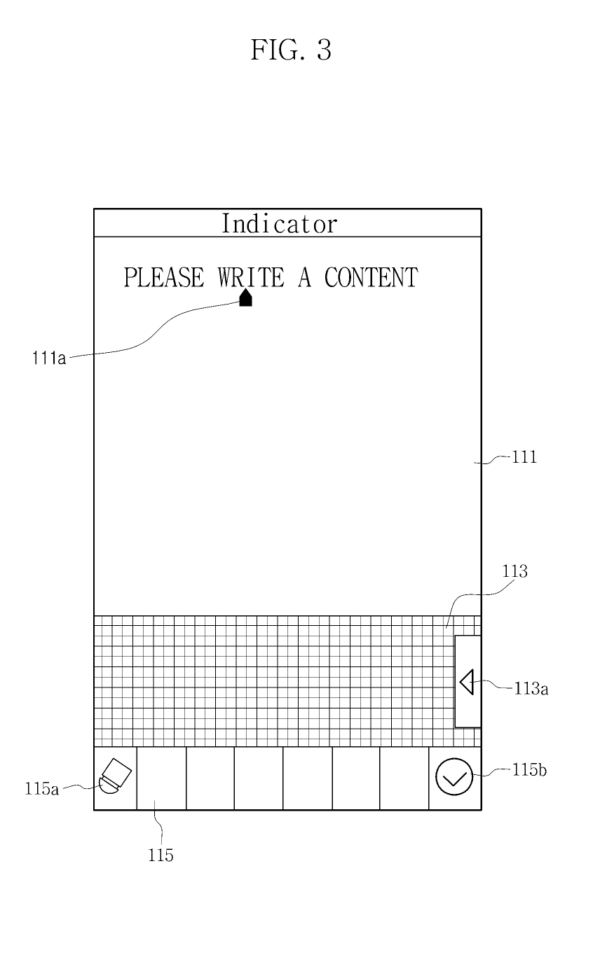

FIG. 2 is a diagram showing a writing interface unit according to an exemplary embodiment of the present invention. FIG. 3 is a diagram showing a handwriting user interface for controlling applications according to an exemplary embodiment of the present invention. Referring to FIG. 2 and FIG. 3, the writing interface unit 110 may include a writing input unit 111, a function input unit 113 and a text editing unit 115. The writing interface unit 110, the writing input unit 111, the function input unit 113, and the text editing unit 115 may also be referred to as a writing interface 110, the writing input interface 111, the function input interface 113, and the text editing interface 115, respectively. Further, one or more operations of a certain unit may be configured in another unit according to different implementation needs.

The writing input unit 111 may display the writing input by the user with or without change in response to the handwriting input of the user and displays a text, obtained by converting the writing input provided from the user by writing recognizing unit 130, to a partial region of the writing input unit 111 (hereinafter, the writing input provided from the user may be referred to as writing data).

The region for receiving writing data and the region for displaying a text may be distinguished, or the entire region of the writing input unit 111 may be used as a region for receiving writing data regardless of the region for displaying a text. When the writing input region and the text displaying region are displayed as a single region, if a user input writing data, the input content may be directly converted into a text or characters by the writing recognizing unit 130. The converted text or characters may be displayed at one side of the writing input unit 111 after a preset or selected font is applied thereto. The input writing and the displayed text may be distinguished with colors.

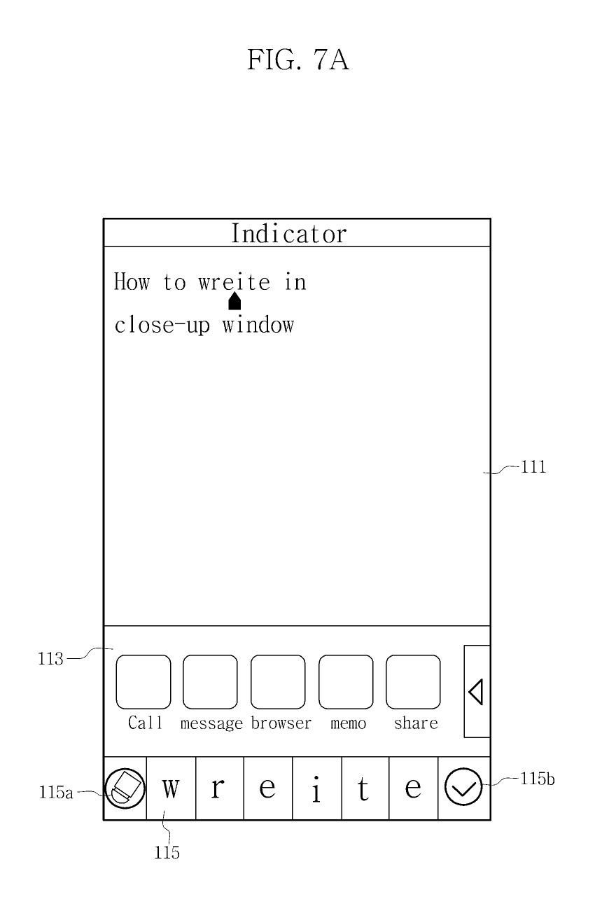

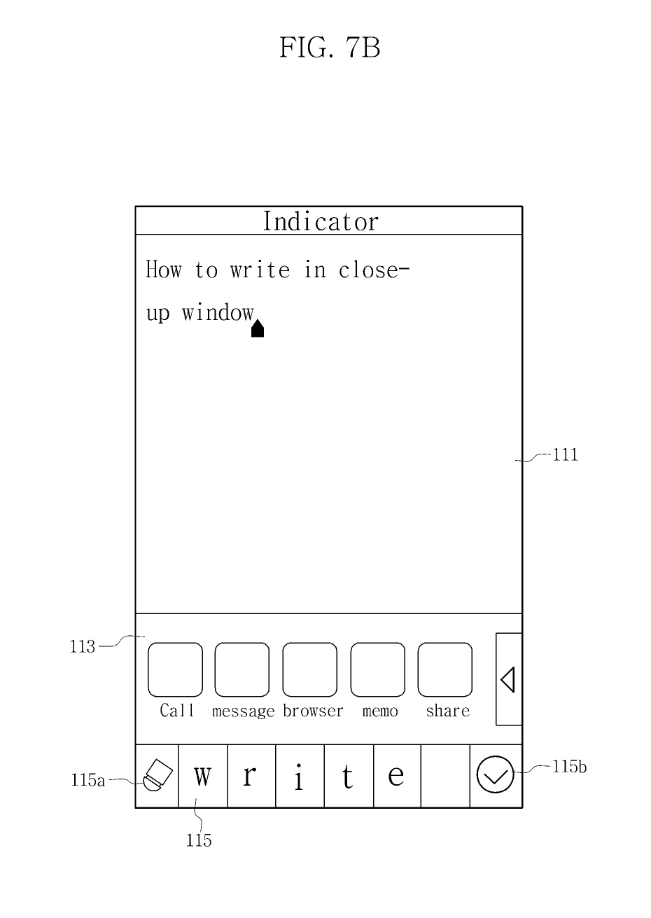

At a terminal in which the text is displayed in the writing input unit 111, a pointer 111a for indicating a location may be displayed to inform how much the text has been input by the user (see e.g., FIG. 7). The pointer 111a is also used for indicating an editing point for a user to edit a text in the text editing unit 115. The writing input unit 111 reflects the edited content at the text editing unit 115 and displays the reflected content in association with the text editing unit 115.

The function input unit 113 allows a user to write function information, e.g., a name of a function or application to be executed, and a symbol or keyword associated with the function (hereinafter, a function name written by the user will be referred to as function information). If the user inputs function information or application name in the function input unit 113, the control unit 150 searches for an application matched with the input function information or application name stored in the storage unit 170 and executes the application in association with the writing data. This will be described later in more detail.

The function input unit 113 may further include an application selection button 113a for providing an available application list instead, without directly inputting the function information or application name by the user. Even though it is described in this embodiment that the application selection button 113a is provided at the function input unit 113, the application selection button 113a may also be used as a confirmation button, which is used for the user to check that the in function information or application name is correct.

The text editing unit 115 is provided for a user to correct the writing input by the user and is divided into a plurality of cells for easy correction. In the text editing unit 115, each letter or character of the text displayed at one side of the writing input unit 111 may be displayed at each cell. For example, the most recently received input, e.g., the most recently inputted word, may be displayed in the writing input unit 111 such that each character of the word is displayed in a corresponding cell.

As shown in FIG. 3, an editing button 115a for executing a text editing function is provided at one side of the text editing unit 115, and a confirmation button 115b for confirming an editing content is provided at the other side. In an example, the editing button 115a is expressed as an eraser-shaped icon and the confirmation button 115b is expressed as a ‘v’-shaped icon, but aspects are not limited thereto.

When the user corrects the text displayed in the writing input unit 111, if the user selects the editing button 115a and then selects a text displayed in a cell to be corrected, among the cells of the text editing unit 115, the corresponding text may be deleted. In another example, the user may also select a text displayed in the cell first and then select the editing button 115a. In still another example, if a text to be corrected is selected first in a portion where a converted text is displayed in the writing input unit 111, the text displayed in the corresponding cell of the text editing unit 115 may be selected and then edited.

Further, after selecting and deleting the text, the user may insert an additional text. The text may be inserted by inputting writing data in the writing input unit 111. The additional text may be inserted in a portion corresponding to the location of the pointer 111a. If the editing content is entirely confirmed, the confirmation button 115b may be selected to reflect the edited content to the writing input unit 111.

FIG. 7A and FIG. 7B are diagrams showing that a text input to a writing input unit is corrected according to an exemplary embodiment of the present invention. For example, as shown in FIG. 7A, if the user inputs “How to wreite in close-up window” in the writing input unit 111, the input content is displayed at one side of the writing input unit 111. If the user selects a portion “wreite” of the writing input unit 111 to correct the text, the word “wreite” is displayed in cells of the text editing unit 115, and the user may edit (or cancel or delete) the corresponding text or characters by selecting the editing button 115a then selecting a text or characters of a desired cell. After that, as shown in FIG. 7B, if the user touches the confirmation button 115b to complete correction, the pointer 111a may be moved to the end of the text displayed in the writing input unit 111, and the editing operation may be completed.

Further, although not shown in the figures, if the user touches the editing button 115a of the text editing unit 115 for a long time or touches a specific preset region for a long time, all texts displayed in the text editing unit 115 may be deleted. Moreover, if a text needs to be inserted in the middle of the texts displayed in the writing input unit 111, the text may be inserted by generating the pointer 111a in a region where the text should be inserted, and then writing the text in the writing input unit 111.

The above-described functions may be performed according to a command from the control unit 150 of the device 100 based on a received user input as described above.

Even though it has been described that the writing interface unit 110 controls overall functions for inputting and displaying writing, it may be also possible that all contents input to and displayed in the writing interface unit 110 are controlled by the control unit 150 based on the writing data recognized by the writing recognizing unit 130, and the writing interface unit 110 may play a role of simply displaying the input content in association with the control unit 150.

The writing recognizing unit 130 may recognize writing data input through the writing interface unit 110. The writing recognizing unit 130 may separately recognize writing data input through the writing input unit 111 and writing data input through the function input unit 113 and convert and store the writing data into a text. The writing recognizing unit 130 may recognize and convert the writing data into a text, and the converted text is transmitted to the control unit 150 and the writing interface unit 110.

Meanwhile, information of a function matched with the function information input by the user and information of an application capable of executing the corresponding function may be mapped and stored in the storage unit 170. The function information may be input as a ‘keyword’ of a preset format, a symbol, a text, and the like.

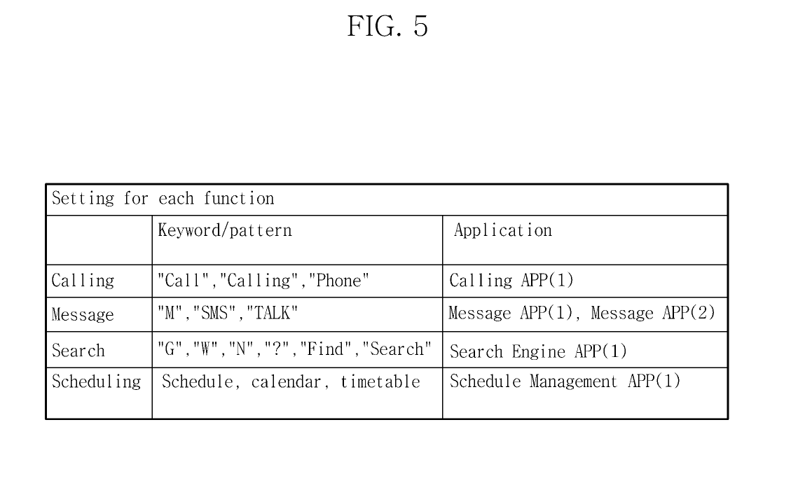

FIG. 5 is a table showing an example of a preset keyword with respect to the function information according to an exemplary embodiment of the present invention. Referring to FIG. 5, in order to make a call, if “call”, “calling” and “phone” are stored and mapped to a phone call application, the user may execute the phone call application by inputting any one of “call”, “calling” and “phone” in the function input unit. This may also be checked in a message sending function and a searching function with reference to FIG. 5.

However, with respect to the message sending function, if two or more applications are associated with the keyword and/or pattern of message sending functions as shown in FIG. 5, the function input unit 113 may display application information, e.g., icons, of the applications and recommend the applications to the user so that the user may select an application by selecting the corresponding application information, e.g., an application icon.

For example, if the user inputs a keyword among “call”, “calling,” and “phone” in the function input unit 113 after writing a phone number in the writing input unit 111, since the corresponding keyword is associated with an application having a calling function, a phone application capable of making a call is mapped and stored.

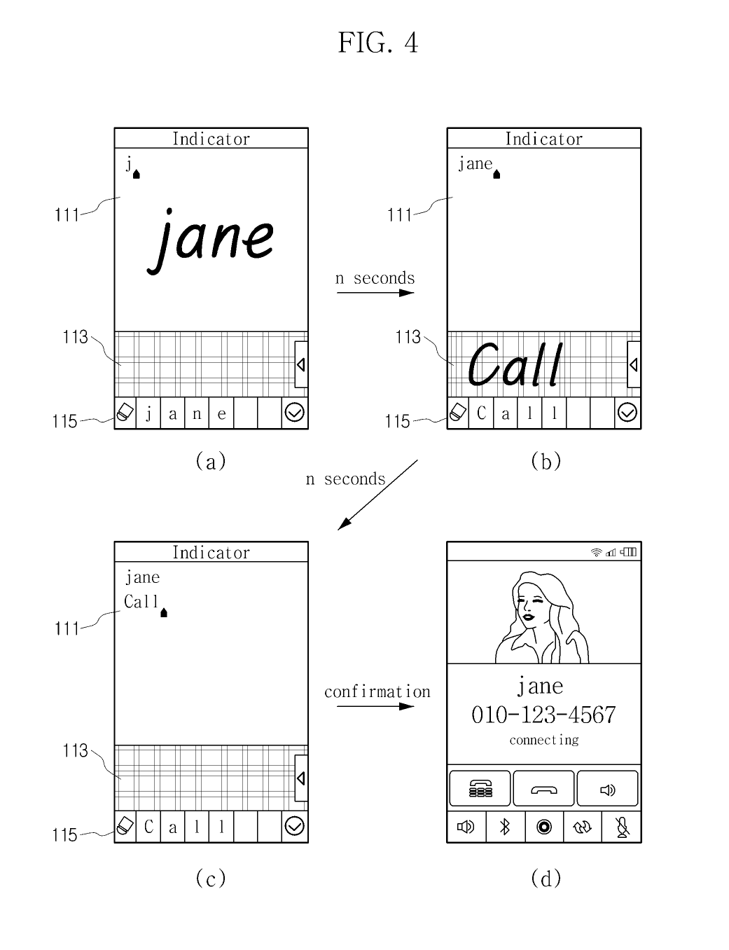

FIG. 4 is a diagram showing an application control function executed based on handwriting data and function information according to an exemplary embodiment of the present invention. FIG. 4 also illustrates a screen shot showing a calling order by using a handwriting input. Referring to FIG. 4, ‘Jane’ is input in the writing input unit 111, and then call is input in the function input unit 113 to make a call to Jane. In this example, a phone number 010-123-4567 of Jane may be stored in the device as the phone number associated with a contact ‘Jane’.

Referring to FIG. 4A, the device 100 displays the text, ‘Jane’, written by the user, and the writing data is converted into a text and displayed in the writing input unit. In the figure (a) of FIG. 4, only ‘j’ is displayed. If the text editing unit 115 completes editing, after a predetermined time (for example, 1 second) or the confirmation button is selected, the text ‘Jane’ may be entirely displayed as shown in figure (b) of FIG. 4.

Referring to the figure (b) of FIG. 4, writing information ‘call’ is input in the function input unit 113. This writing information may also be converted into a text and each alphabet character or other symbol inputted by the user may be displayed in the text editing unit 115 as shown in the figure (b) of FIG. 4.

The text ‘call’ input in the function input unit 113 may be displayed in the writing input unit 111 as shown in figure (c) of FIG. 4.

As described above, if the writing data ‘Jane’ and the function information ‘call’ are input, the control unit 150 may interpret the information and execute an application for making a call to ‘Jane’ as shown in figure (d) of FIG. 4. This execution may be performed by the selection of the user or automatically after a predetermined time. The data received in the writing input unit 111 and the data received in the function input unit 113 may be associated with each other and the data received in the function input unit 113 may be interpreted based on the data received in the writing input unit 111 or vice versa.

The user may write an application name in the writing input unit 111. For example, the user may input an application name or a preset keyword corresponding to the application name.

For example, if the user inputs an abbreviated keyword ‘P’ instead of an application name, an application made by ‘PANTECH’ mapped with the keyword ‘P’ is stored in or retrieved from the storage unit 170.

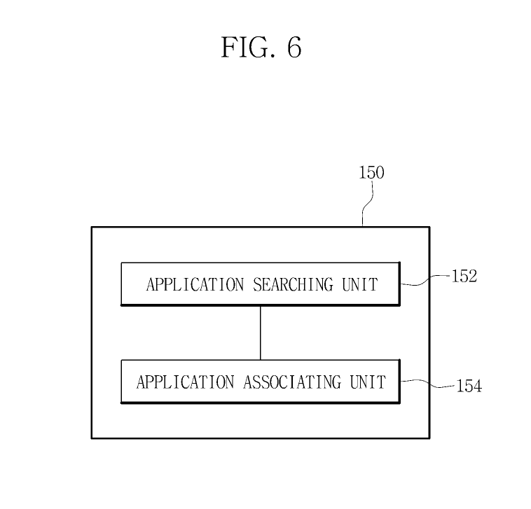

FIG. 6 is a diagram showing a control unit according to an exemplary embodiment of the present invention. The control unit, e.g., control unit 150, may include an application searching unit 152 and an application associating unit 154. However, the control unit 150 may also perform all functions of these components, without divided into these components.

The control unit 150 may receive the writing data input through the writing interface unit 110 and/or the text converted by the writing recognizing unit 130.

The application searching unit 152 searches for an application mapped with the function information or the application name input to the function input unit 113 from the storage unit 170 and transmits the application to the application associating unit 154.

The application associating unit 154 executes the application searched for and retrieved by the application searching unit 152 and associates the writing data input through the writing input unit 111 with the retrieved application.

If it is determined that an application mapped with the function information input by the user is not present in the storage unit 170, the control unit 150 may provide an available application list through the function input unit 113 so that the user may directly select an application to be mapped with the function information. In addition, in the case an application mapped with the function information input by the user does not exist, the control unit 150 may provide an application for performing a searching function to the function input unit 113. The searching application may be provided as a default to the function input unit 113.

Moreover, when the text input in the writing input unit 111 is a determined symbol or a specific text, the control unit 150 displays a corresponding function icon in the function input unit 113. For example if a ‘? (question mark)’ symbol is input, a search icon for executing an application which performs a searching function may be displayed. Further, if an expression including an arithmetic operation symbol, e.g., four operators, is input, a ‘=(equal mark)’ icon for executing an application which provides a calculating function may be displayed.

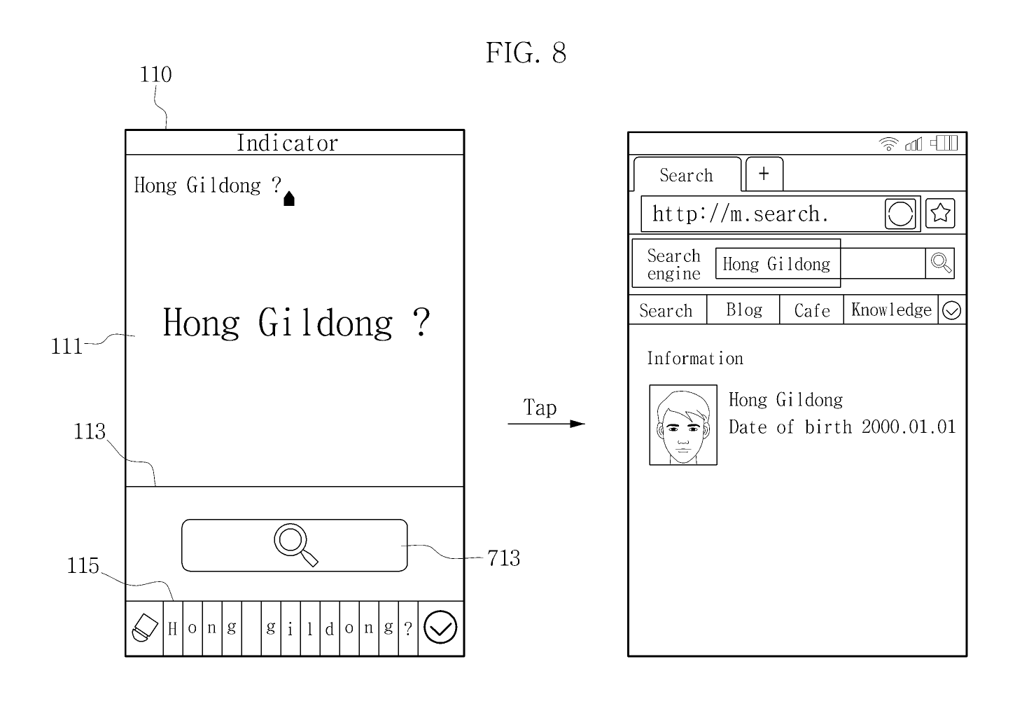

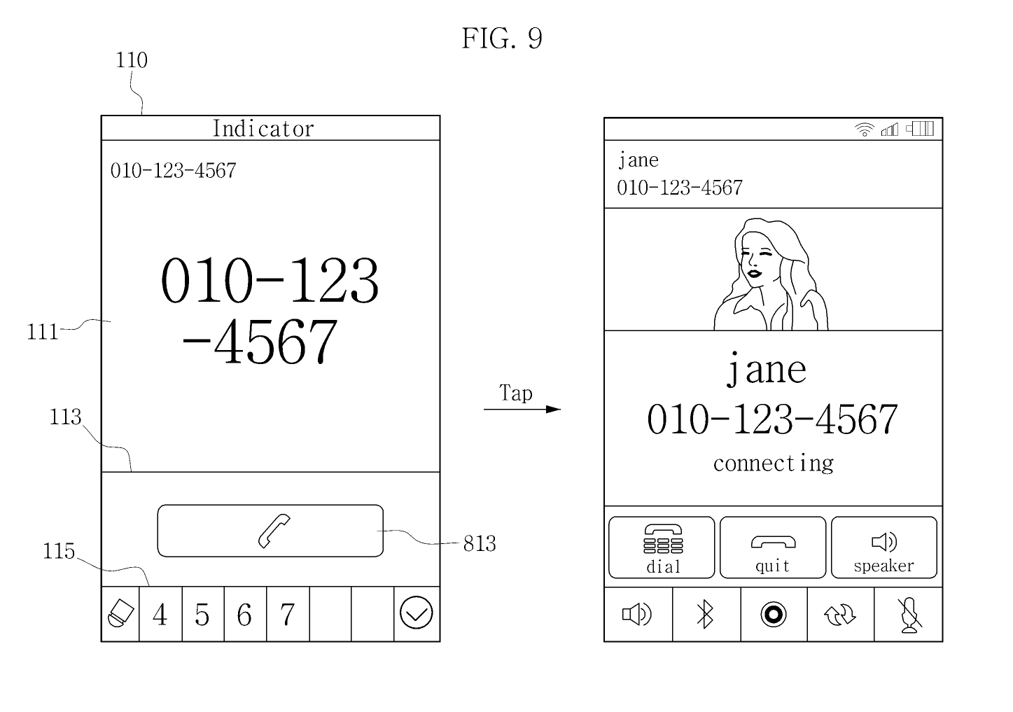

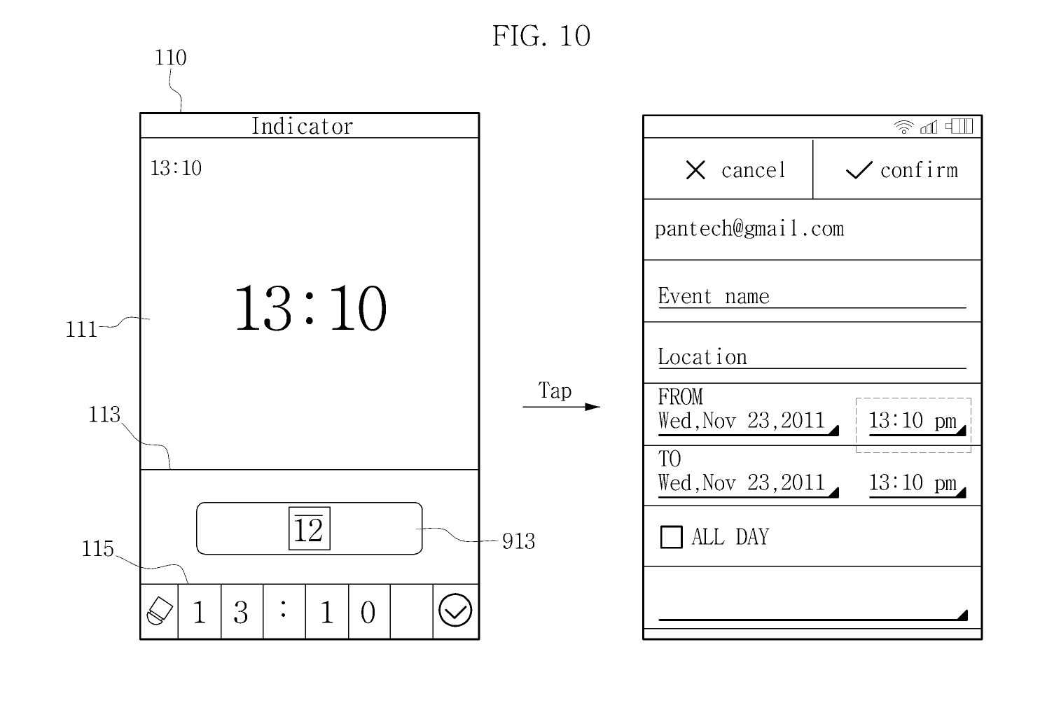

Various features and examples will be described in more detail with reference to FIG. 8, FIG. 9, and FIG. 10.

FIG. 8 is a diagram showing an application for performing a searching function recommended based on a text input to the writing input unit is executed according to an exemplary embodiment of the present invention. Referring to FIG. 8, if the user writes “Hong Gildong?” in the writing input unit 111, the writing recognizing unit 130 recognizes the input writing and extracts and converts writing data “Hong Gildong?” into a text. Since the text converted in the writing recognizing unit 130 may be displayed at the top of the writing input unit 111, the writing input by the user and the converted text may be displayed in the writing input unit 111 simultaneously. Since “Hong Gildong?” extracted by the writing recognizing unit 130 includes “? (question mark)”, the control unit determines that the user has an intension of searching, then searches for a web browser application having a searching function and provides the application to the function input unit 113, but aspects are not limited as such. The searching function may be executed by other configurations by recognizing another symbol, receiving a touch input, or location of the writing of the user. After that, if the user touches a web browser searching application execution icon 713 to execute the web browser searching application, the web browser searching application may be executed in association with the writing data “Hong Gildong” without including the question mark in the search query, and the search result may be displayed. Further, the specific symbol “?” may indicate searching contacts, pictures, and the like, and if a search scope is determined by a writing input in the function input unit 113, the search may be performed in the search scope determined by the writing input in the function input unit 113. For example, if “Jane?” is received in the writing input unit 111 and “gallery” is received in the function input unit 113, pictures associated with the text “jane” may be retrieved from the gallery application.

FIG. 9 is a diagram showing an operation of executing an application for performing a call generating function recommended based on a text input to the writing input unit according to an exemplary embodiment of the present invention. Referring to FIG. 9, if the user writes “010-123-4567” in the writing input unit 111, the writing recognizing unit 130 recognizes the input writing, extracts the writing data “010-123-4567” and converts the writing data into a text or characters. Since the text converted by the writing recognizing unit 130 is displayed at the top of the writing input unit 111, the writing input by the user and the converted text are displayed in the writing input unit 111 simultaneously. Since the distinctive information extracted from the writing data is composed of number data or characters and specific identifier (−) data or characters and satisfies a phone number format, the control unit 150 may determine that the user has an intension of using a phone number and display a relevant application in the function input unit 113. FIG. 9 illustrates an example in which a phone application icon 813 is provided in response to writing data corresponding to a phone number. If the user selects the phone application execution icon 813 to execute a phone application, the phone application is executed in association with the writing data “010-123-4567”.

FIG. 10 is a diagram showing an operation of executing an application for performing a scheduling function recommended based on a text input to the writing input unit according to an exemplary embodiment of the present invention. Referring to FIG. 10, if the user writes “13:10” in the writing input unit 111, the writing recognizing unit 130 recognizes the input writing, extracts the writing data “13:10” and converts the writing data into a text. Since the text converted in the writing recognizing unit 130 is displayed at the top of the writing input unit 111, the writing input by the user and the converted text are displayed in the writing input unit 111 simultaneously. Since the distinctive information extracted from the writing data includes symbol data “:” and satisfies a time format in 24 hour notation, the control unit 150 searches for a scheduling application 913 and displays the scheduling application 913 in the function input unit 113. After that, if the user touches the scheduling application execution icon 913 to execute a scheduling application, the scheduling application is executed in association with the writing data “13:10”.

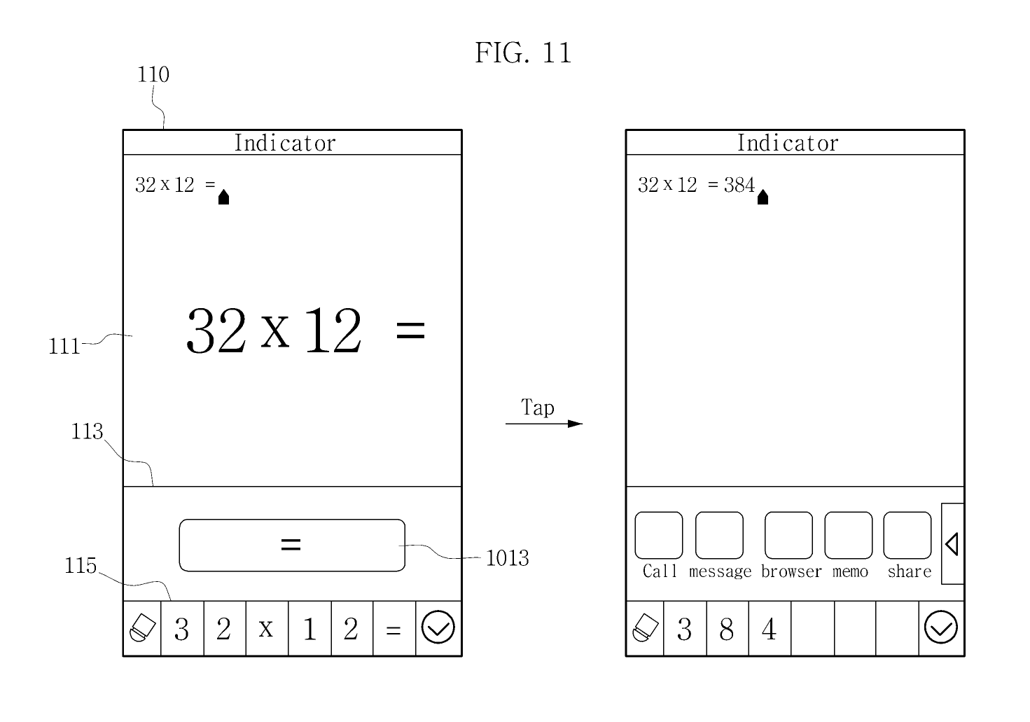

FIG. 11 is diagram showing an operation of executing an application for performing a calculating function recommended based on a text input to the writing input unit according to an exemplary embodiment of the present invention. Referring to FIG. 11, if the user writes “32×12=” in the writing interface unit 110, the writing recognizing unit 130 recognizes the input writing, extracts the writing data “32×12=” and converts the writing data into a text. Since the text converted in the writing recognizing unit 130 is displayed at the top of the writing input unit 111, the writing input by the user and the converted text are displayed in the writing input unit 111 simultaneously. Since the distinctive information extracted from the writing data is composed of number data and arithmetic operators, the control unit 150 may search for a calculator application and provides the calculator application to the function input unit 113. After that, if the user selects an application execution icon 1013 to execute a calculator application, the calculator application may be executed in association with the writing data “32×12=”, and the calculation result may be displayed.

As described above, if a preset symbol or format is satisfied, the control unit 150 may search for one or more applications and provide the retrieved application, which may be a preset application associated with the symbol or format, to the function input unit 113, and the user may change the setting of an application to be provided according to the corresponding symbol or format.

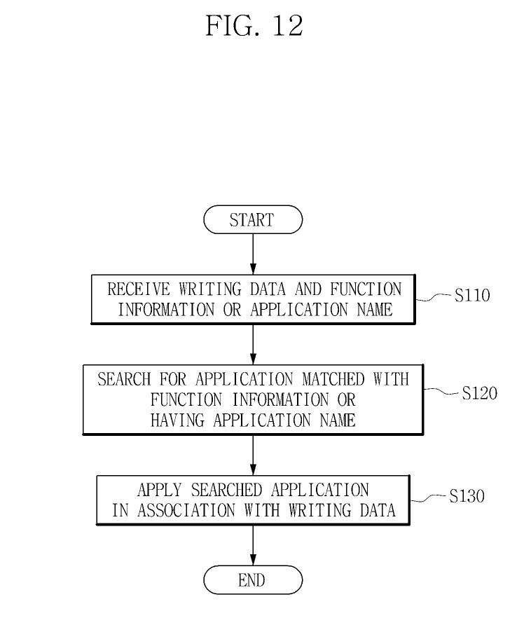

Hereinafter, a method for executing a particular function based on writing will be described with reference to FIG. 12 (a reference symbol of each component will be described with reference to the former embodiments and drawings).

FIG. 12 is a flowchart illustrating a method for implementing a function based on a handwriting input according to an exemplary embodiment of the present invention. FIG. 12 will be described as if performed by the device 100 shown in FIG. 1, FIG. 2, and FIG. 3, but is not limited as such. As shown in FIG. 12, the device 100 receives writing data from a user through the writing input unit 111 provided at the writing interface unit 110 and receives function information or an application name from the user (operation S110). The control unit 150 searches for an application (or an application group) mapped with the received function information or searches for the input application, based on the writing data (operation S120). In response to the search, associated applications may be retrieved. In addition, the control unit 150 provides the retrieved application in association with the writing data (operation S130).

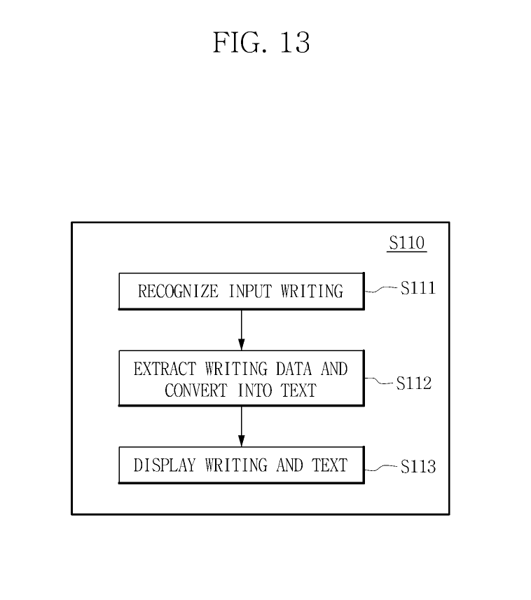

FIG. 13 is a flowchart illustrating an operation of receiving information according to an exemplary embodiment of the present invention. FIG. 13 will be described as if performed by the device 100 shown in FIG. 1, FIG. 2, and FIG. 3, but is not limited as such. As shown in FIG. 13, the receiving of writing data from a user (the operation S110 of FIG. 12) may include recognizing writing input, which is input to the writing recognizing unit 130 (operation S111) and extracting writing data and converting the writing data into a text (operation S112). The converted text may be displayed at one side of the writing input unit 111 together with the writing content of the user (operation S113) or the writing content of the user may be displayed and then converted into the text.

Further, the writing data may be received at the writing input unit 111, and the function information or application name may be received at the function input unit 113.

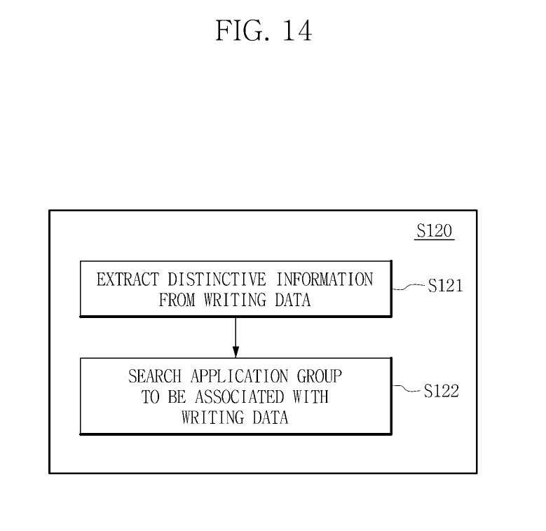

FIG. 14 is a flowchart illustrating an operation of searching for a specific application according to an exemplary embodiment of the present invention. As shown in FIG. 14, the searching of an application group (the operation S120 of FIG. 12) may include extracting distinctive information from the writing data (operation S121) and searching for an application group to be associated with the writing data (operation S122). More specifically, distinctive information of the writing data may be extracted based on the writing data extracted at the writing recognizing unit 130, and an application group to be associated with the writing data may be searched according to the extracted distinctive information.

The distinctive information may be a name, a phone number, an address, an email address, a time, an expression having arithmetic operators or the like.

If the writing data does not correspond to the above distinctive information in the extracting of distinctive information (operation S121), an application for performing a searching function may be provided to the user through the function input unit 113.

The application group provided by the control unit 150 may be displayed in the function input unit 113 in an icon form. If the distinctive information corresponds to an input of a preset symbol or text, a function icon corresponding to the symbol or text may be displayed in the function input unit 113.

The device 100 may include one or more processors, storage devices, such as memories, touch screen displays, which may sense a touch input of a user's finger or a touch pen, and the like. The units, modules, elements, and components of the devices and/or mobile terminals herein described, may include hardware and software, may also include firmware, to perform various operations of the device including those described herein, and may be combined or remain separate as described.

Further, the storage unit 170 of the device 100 may include a database for application information or application metadata. The application information or application metadata may include application name, information about functions of each application, data fields for an application, data fields for a certain function of an application, various kinds of metadata for an application, and the like. Data entry of the converted text recognized from a writing input may be compared with the application information or the metadata to retrieve one or more functions associated with the data entry or one or more applications associated with the data entry. The converted text or characters may further include a specific symbol, e.g., “?”, as illustrated in FIG. 8. The specific symbol may be mapped to an application or a certain function of an application. Further, a combination of a button key input and a writing input may execute a certain function of an application. For example, if a user writes a character “c” in the writing interface unit 110 and presses a home button, an application for managing contacts of a user may be executed.

The device 100 may provide a writing translation database. The writing translation database may include translation data customized for the writing translation, a web-searched translation data or an installed dictionary application. If a user writes a word in a first language, e.g., English, the writing translation database may translate the word into a second language to search for applications including application information or application metadata represented in the second language.

If an associated function or application is not retrieved in response to a writing input, application list may be provided to associate the writing data to a selected application.

The exemplary embodiments described in the specification may be recorded in non-transitory computer-readable media including program instructions to implement various operations embodied by a computer. The method and apparatus according to exemplary embodiments of the present invention may be implemented by hardware and/or software configurations. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention. In the specification, the term “unit”, “module”, “system” or the like indicates a computer-related entity like hardware, a combination of hardware and software, or software. For example, the term “unit”, “module”, “system” or the like used in the specification may be a process, a processor, an application specific integrated circuit, an object, an executable file, a thread of execution, a program, and/or a computer, without being limited thereto. For example, both a computer and an application executed in the computer may correspond to the term “unit”, “module”, “system” or the like in the specification.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for providing an application interface based on a writing input, the method comprising:
providing a writing interface comprising a writing input interface in a first area of the writing interface and a function input interface in a second area of the writing interface, the writing input interface being configured to receive and display a first writing input, and the function input interface being configured to receive a second writing input;
based on the first writing input and/or the second writing input, determining a function of an application; and
executing the determined function of the application in association with the first writing input and/or the second writing input.

2. The method of claim 1, further comprising converting the first writing input to a converted text,
wherein the function input interface is configured to display, in response to the converted text of the first writing input, one or more retrieved applications associated with the converted text.

3. The method of claim 2, further comprising displaying a pointer to indicate a location in the converted text.

4. The method of claim 2, wherein the writing interface further comprises a text editing interface to edit the converted text.

5. The method of claim 4, wherein the text editing interface comprises cells and each portion of the converted text is displayed in one of the cells.

6. The method of claim 5, wherein the portion of the converted text is selectable by a selection input of a user.

7. The method of claim 2, wherein the function of the application is determined based on a format of the first writing input, a preset character included in the first writing format, or a converted text of the second writing input.

8. The method of claim 1, wherein the writing input interface is configured to determine a text from the first writing input, the text comprising a data entry utilized for the function of the application, and
the function input interface is configured to recognize an application name and/or the function of the application from the second writing input.

9. The method of claim 8, wherein the text further comprises a symbol associated with a function of a search application.

10. A method for providing an application interface based on a writing input, the method comprising:
providing a writing interface configured to receive a first writing input and a second writing input;
recognizing a data entry from the first writing input, the data entry being utilized by a function of one or more applications;
determining a function of a first application corresponding to the second writing input; and
executing the function of the first application by utilizing the data entry.

11. The method of claim 10, wherein the writing interface comprises:
a writing input interface in a first area of the writing interface to receive the first writing input; and
a function input interface in a second area of the writing interface to receive the second writing input.

12. The method of claim 10, further comprising displaying the one or more applications associated with the data entry recognized from the first writing input.

13. The method of claim 10, wherein the writing interface further comprises a text editing interface to edit a first text converted from the first writing input or a second text converted from the second writing input.

14. The method of claim 10, wherein the writing interface displays a first text converted from the first writing input, the first text comprising the data entry and a symbol associated with a function of a second application.

15. The method of claim 13, wherein the second text corresponds to an application name of the first application or corresponds to the function of the first application.

16. A method for providing an application interface based on a writing input, the method comprising:
providing a writing interface comprising a writing input interface in a first area of the writing interface and a function input interface in a second area of the writing interface, the writing input interface being configured to receive a first writing input, and the function input interface being configured to display, in response to the first writing input, one or more retrieved applications associated with the first writing input; and
displaying the one or more retrieved applications associated with the first writing input; and
in response to a selection of an application from among the one or more retrieved applications, executing a function of the selected application in association with the first writing input.

17. The method of claim 16, wherein the writing input interface displays a first text converted from the first writing input, and
wherein if the first text comprises a data entry and a symbol associated with a function of a first application, the first application is displayed in the function input interface.

18. The method of claim 17, wherein the function of the first application is executed by utilizing the data entry if the displayed first application is selected.

19. The method of claim 16, wherein the writing input interface displays a first text converted from the first writing input, and
wherein if the first text corresponds to a registered format associated with a function of a first application, the first application is displayed in the function input interface.

20. A device for providing an application interface based on a writing input, the device comprising:
a writing interface unit providing a writing interface comprising a writing input interface in a first area of the writing interface and a function input interface in a second area of the writing interface, the writing input interface being configured to receive and display a first writing input, and the function input interface being configured to receive a second writing input; and
a control unit, based on the first writing input and/or the second writing input, determining a function of an application and executing the determined function of the application in association with the first writing input and/or the second writing input.

21. The device of claim 20, further comprising a writing recognizing unit converting the first writing input to a converted text,
wherein the function input interface is configured to display, in response to the converted text of the first writing input, one or more retrieved applications associated with the converted text.

22. The device of claim 20, wherein the control unit is configured to determine a text from the first writing input, the text comprising a data entry utilized for the function of the application, and
the function input interface is configured to recognize an application name and/or the function of the application from the second writing input.
